(19) United States
(12) Patent Application Publication
(10) Pub. No.: US 2009/0084020 A1
(43) Pub. Date: Apr. 2, 2009

(54) Fish length and weight measuring device

(76) Inventor: Bobby Sorey, Chesapeake, VA (US)

Correspondence Address: Bradley D. Goldizen, One Columbus Center, Ste. 665, Virginia Beach, VA, 23462, US

(21) Appl. No.: 11/906,280

(22) Filed: Oct. 1, 2007

(51) Int. Cl. A01K 97/00

(52) U.S. Cl. 43/25; 43/4

(57) ABSTRACT

A fish length and weight measuring device includes a tape measure having graduated markings displayed on at least one side thereof and a weight measuring hook extending from the device opposite the tape measure. Loop fasteners are provided on a back side of the device for coupling it the butt end of a fishing rod. The measuring device may include a housing having a transparent face through which the weight of a measured fish is displayed on a digital display. A power supply is coupled to the display. A fish is easily measured by hooking the end of the tape measure into the mouth of the fish and extending it along the length of the fishing rod. The fish is easily measure by gripping the butt of the pole and hooking the fish onto the weight measuring hook. In this manner, a fisherman can easily determine whether the fish is a keeper or can accurately measure the size and weight of a caught fish.

There are no related patent applications.

This application did not receive federal funding.

### BACKGROUND OF THE INVENTION

The present invention generally relates to a detachable device that is preferably coupled to a butt end of a fishing rod for measuring and weighting a fish. More particularly, the present invention relates to a tape measure that is stored as a coil within the device and extends from an upper end of the measuring device through an opening in an external case. A free end of the tape measure includes a hook for measuring a length of a fish. A second hook extends through the lower end of the case is coupled to a weight measuring means and arranged to hang a fish thereon for weight measurement purposes. A front side of the device includes a display that is arranged thereon to display weight measurements. A power source is arranged within the device for powering the display screen and, if necessary, the weight measuring means.

To prevent over fishing and create sustainable fisheries, many federal and state agencies have passed legislation that requires the release of certain sized fish. Thus, many species of game fish have length and/or weight restrictions that require the fisherman to release smaller or larger sized fish. Still others enjoy the sport of catch-and-release fishing. Absent a camera to record the moment, it is difficult to accurately obtain an accurate length and weight for a fish that has been caught. Previously, fish were measured with tape measures that were used in the construction industry. While the length of the fish could be measured, it was difficult to for the user to achieve such measurements when fishing from a boat in rough seas or fishing in fast moving current during wading. Moreover, scales are also difficult to use during these conditions.

To ensure compliance with the aforementioned regulations, several devices were invented. U.S. Pat. No. 7,237,356 to Reynolds discloses a combination fishing accessory device that includes tools for aiding a fisherman. A tape measure is included in the device and used as shown in FIG. 7. This device is difficult to use for measuring purposes because the tape measure extends downward. The device is arranged between the reel and the distal end of the fishing rod. Several feet of the rod extends between the device and the distal end. This makes maneuvering the rod during measuring procedures difficult. Moreover, it may be impossible to effectively use the tape measure when measuring large fish having a length longer than the distance between the device and the proximal end.

U.S. Pat. No. 4,969,286 to Belanger discloses a fishing rod and measuring device that may be integrally formed onto the surface of the fishing rod. In this instance, the fish are measured by comparing them with the marks formed on the fishing rod. Over time these marks may dull or fade become worn off from exposure to the elements and prohibiting accurate length measurements.

U.S. Pat. No. 4,995,188 to Ewing discloses a fishing rod and method for weighting fish. A calibrated compression spring is arranged within a bore of the handle for weighting caught fish. Still other devices are known to be used to measure the weight of a fish.

None of the prior art includes a tape measure arranged within a housing having a digital display on one side thereof and being coupled to a handle of a fishing pole. The digital display exhibits the weight of a fish coupled to a lower end thereof.

### BRIEF SUMMARY OF THE INVENTION

The present invention is a device for both measuring a length and weight of a fish. The device fastens onto the handle of a fishing pole and includes at least one Velcro® fastening strap that squeezes the exterior material of the handle to fasten a formed loop of solid material extending from a back side of the housing. The device is preferably arranged on a side of the handle opposite the reel. A tape measure is arranged within the housing that protects the internal workings of the device.

The housing preferably includes a front section and a back section. A seal is arranged between the front section and the back section of the housing. An upper opening is arranged on a top edge of one of the sections to allow the tape measure to be extended from the device or retracted back into the device. A seal is arranged around the upper opening through which the tape measure extends as discussed. The seal prevents adverse environmental conditions from entering the casing and causing damage to the inner workings of the device. The tape measure includes a stop for preventing the free end of the tape measure from entering into the housing and piercing the seal. The tape measure is wound onto a spring-biased spool that automatically rewinds the tape measure into the device when not in use.

In one embodiment, the front section includes a clear window through which a digital readout provides the measured weight of a fish. The back region of the housing is solid and includes an opening for accepting a power source such as a battery. The front and back portions of the casing preferably includes a rubber seal arranged there between. A lower opening is arranged in the housing through which a lower hook extends. In an additional embodiment, the device includes a housing that comprises a bulbous end arranged at an upper end. The lower end may include a loop portion formed on a backside of the device for accepting an adjustable coupler that secures the device to the handle of the fishing pole. The terms “upper” and “lower” are relative to the distal end of a fishing pole, during use where the distal end is referenced as the “upper end”.

The lower hook is preferably coupled to an electronic weight measuring device such as a strain gauge. Such strain gauge may include that as disclosed in U.S. Pat. No. 4,660,666, which is incorporated by reference hereto. A fish is attached to lower hook while the angler grasps the handle of the pole above the device. The weight measurement takes place by simply hooking the head of the fish onto the lower hook and biasing the butt of the pole handle away from the body of the fish to allow a free measurement to occur. It should be noted that the weight measuring device may incorporate a simplified version that includes a spring having a spring constant equal to a desired amount of weight. An upper end of the spring is secured to the housing. An indicator is coupled to the lower end of the spring and extends through an opening of the front of the housing. The front of the housing includes graduated marks that correspond to a weight applied to the spring.

The device may be produced for use on a lightweight spinning or fly rod with a spring having a spring constant that is equal to eight pounds. Eight pounds is a large size for fish caught on such a spinning or fly rod. Otherwise, the device may be produced in larger sizes and having a stronger spring with a larger spring constant. For example, the device may be produced with a spring constant that equals forty pounds when the spring is fully extended.

It is an object of the invention to provide a fish measuring device that includes a length measuring device and weight measuring device with an electronic display that exhibits the weight of a fish.

It is another object of the invention to provide a fish measuring device that includes a window through which a digital weight of a fish is displayed.

It is another object of the invention to provide a fish measuring device that includes a housing having a backside that includes a coupling means for securing the device to the handle of a fishing pole.

It is a further object of the invention to provide a fish measuring device that will both measure the length and weight of a fish.

The above and further objects, details and advantages of the invention will become apparent from the following detailed description, when read in conjunction with the accompanying drawings.

### BRIEF DESCRIPTION OF THE DRAWINGS

FIG. 1A is a perspective view of the device from the front. FIG. 1B is a perspective view of the device from the rear. FIG. 1C is an exploded view of the device. FIG. 1D is a cross section view of the device.

FIG. 2 shows the device on a fishing rod.

FIG. 3 shows the device being used to weight a fish.

FIG. 4 shows the device being used to measure a length of a fish.

FIG. 5A shows a front view of a simplified embodiment of the device. FIG. 5B is a back view of the simplified embodiment.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

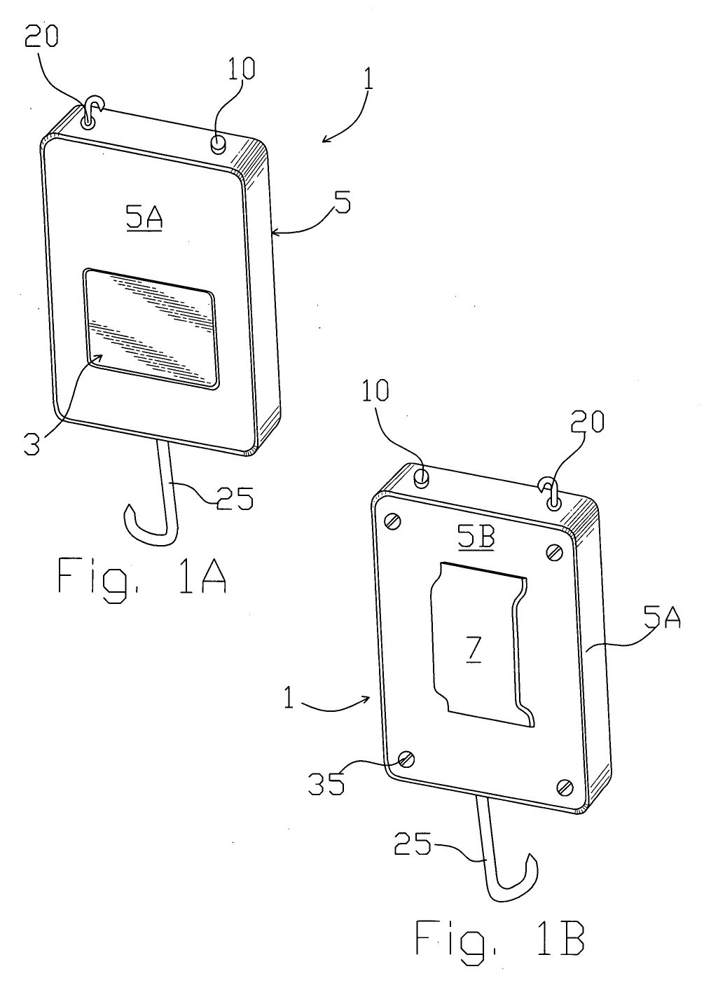

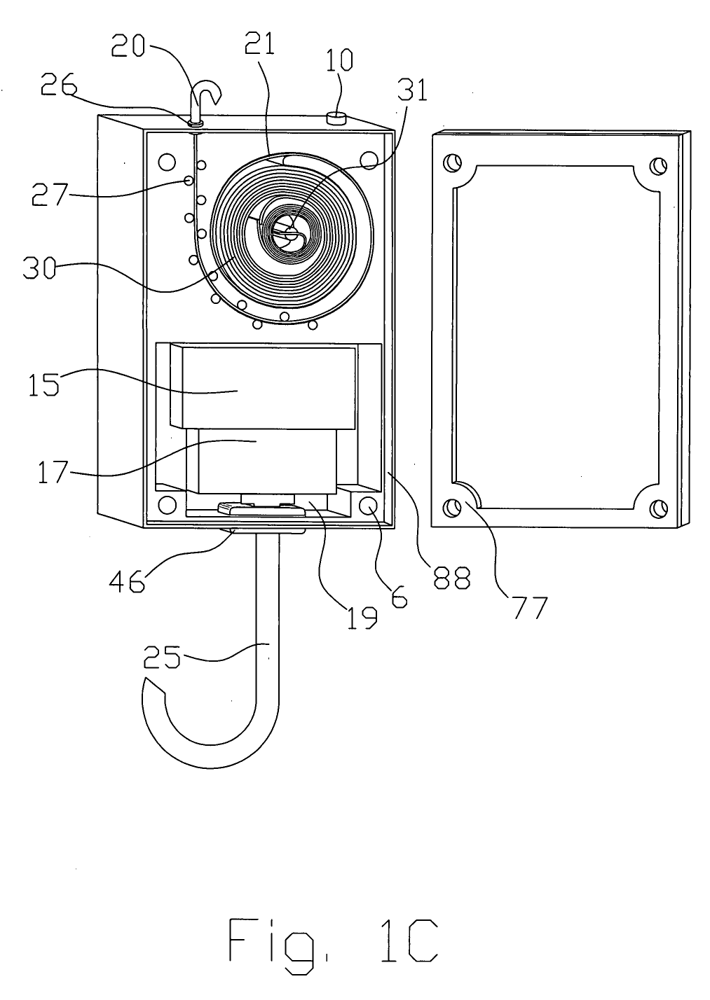

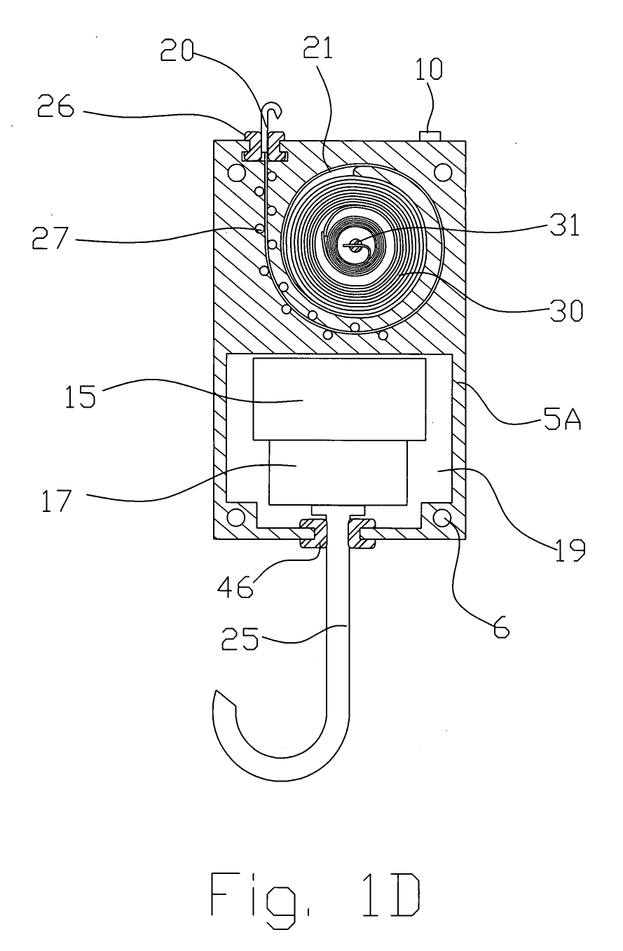

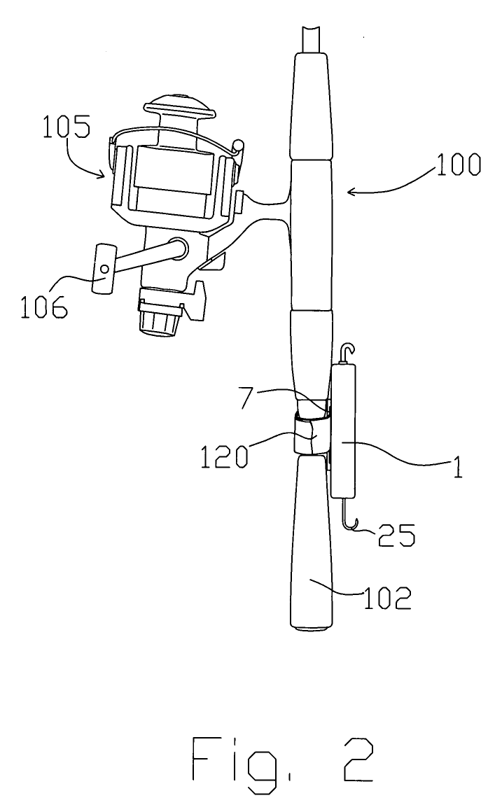

As shown in FIG. 1A, the device 1 includes a housing 5 that comprises front case 5A and back case 5B which is nested within the front case 5A as shown in FIG. 1B. In this embodiment, the front case 5A includes a transparent region or window 3 through which a weight of a fish is displayed on a digital display. A hook 25 extends from a bottom edge of the housing 5 for weighting fish. A power switch 10 is included along one of the top, bottom, left or right edges of the device for powering the digital display and electronic circuitry for weighing a fish. The switch 10 may include a membrane for preventing environmental conditions from entering the device 1. The back case 5B is nested within the front case 5A and fastened thereto via threaded fasteners 35 that extend through the back case 5B and into the front case 5A. A fastening means 7 is formed on an exterior surface of the back case 5B for receiving a strip of Velcro® 120 to fasten the device onto a fishing rod 100 as shown in FIG. 2. Preferably, the fastening means 7 is a loop that is formed on an exterior side of the back case 5B.

The device 1 is shown in cross section in FIG. 1D. A tape measure 21 is coiled around a rewinding spring 30 which connects at an opposite end to a support stud 31. A track is formed between support guides 27 for ensuring smooth extension and retraction of the tape measure 21 during length measuring procedures. A free end 20 extends from the tape 21 and is formed in the shape of a hook for easily measuring a length of a fish. A seal 26 is arranged in an opening through which the tape 21 is played out.

The lower half of the front case 5A includes a digital display 15 arranged atop a printed circuit board 19. A weight measuring means 17 is also arranged atop the printed circuit board 19 and provides a control signal to the digital display 15 that is representative of the weight of a fish. A hook 25 connects at one end to the weight measuring means 17 and extends through an opening in the casing 5A. A seal 46 may be optionally provided as shown. The front case 5A includes openings 6 for receiving threaded fasteners 35. A seal 77 is provided along a lip 88 to prevent moisture from entering the device 1 along a length of the sides as more clearly shown in FIG. 1C.

In FIG. 2, the device 1 is attached to a handle end 102 of the fishing rod 100. Typically, the fishing rod includes a reel 105 that comprises a reel handle 106. The reel 105 shown is commonly referred to as an open-faced reel. Other types of reels may be mounted onto the fishing rod 100 for use with the invention. A Velcro® strip 120 passes through the fastening means 7 that comprises a fastening loop as shown in FIG. 1B.

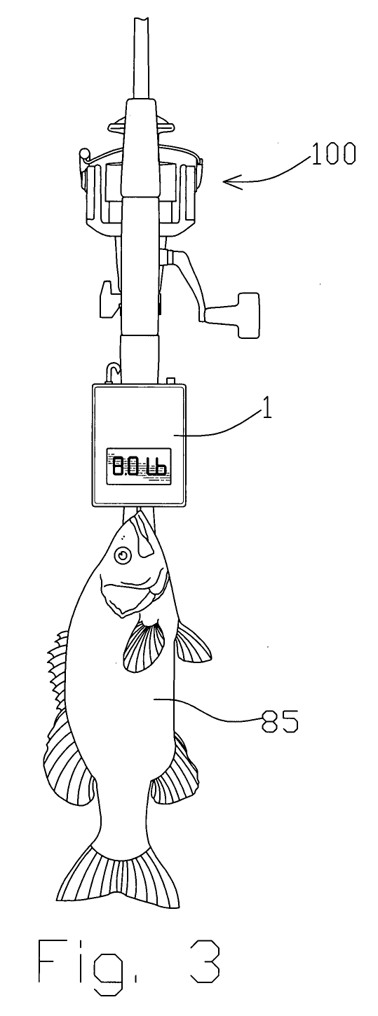

As shown in FIG. 3, a fish 85 hangs from hook 25. The digital display indicates that the fish weighs eight pounds. The fishing pole 100 may be held above the reel and the fish attached to the hook 25. It should be noted that the tip of the pole may be tilted such that the side of the fish does not touch the handle 102 of the pole. This eliminates the any friction forces created between the fish and the handle that may cause an inaccurate weight measurement.

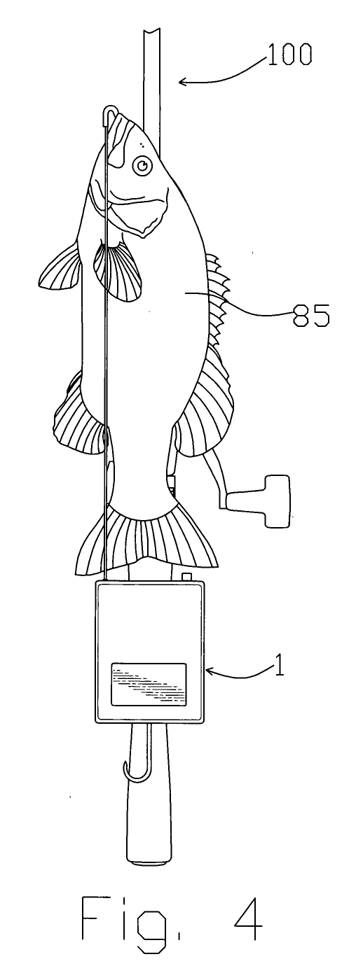

In FIG. 4, a length of a fish is measure using the tape measure that extends from a top edge of the device. The hook 20 is attached to the mouth of the fish 85 as shown. While supporting the fish with one hand, the fisherman grasps the pole and allows the fish to slide along the backside of the pole until the tape measure is extended to the appropriate length. The fisherman can then read the length of the fish from the graduated marks that are provided along the length of the tape measure.

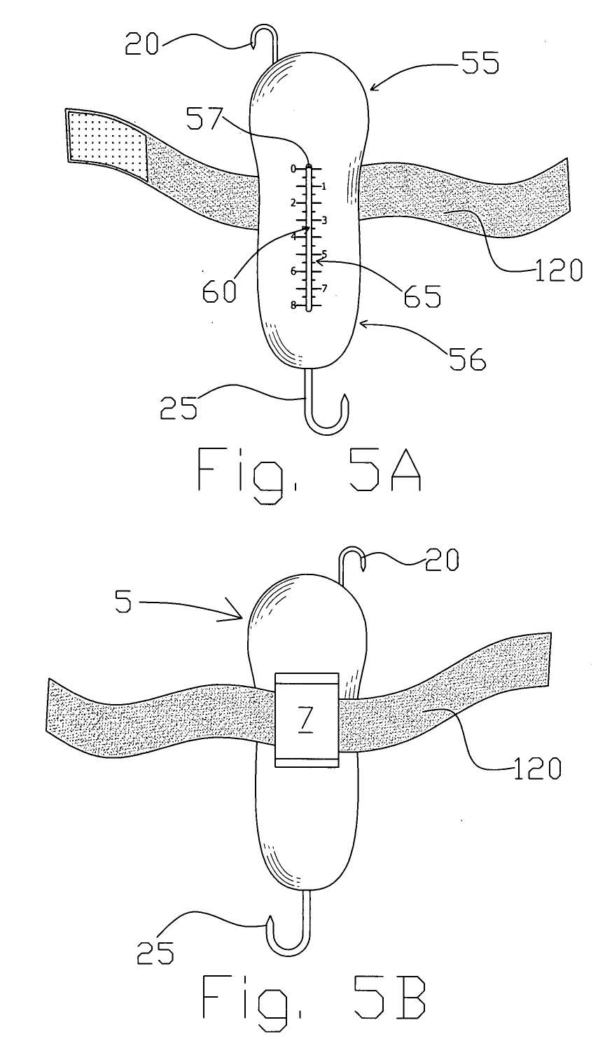

FIGS. 5A and 5B are a simplified version of the device. In these figures, the device includes a bulbous portion 55 arranged atop an elongated slender portion 56. The housing 5 includes an elongated opening 60 having graduated marks 65 thereon that represent a weight of a fish. In this instance, the device 1 may comprise a spring (not shown) that includes an indicator 57 that extends through the elongated opening 60 and attaches to the spring. The weight of the fish is measured by simply hooking the fish onto the hook 25 and weighting it as before.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A fish calculator that measures the length and weight of a fish, said calculator comprising:
a retractable tape measure arranged at an upper end of the fish calculator;
a weight measuring means arranged at a lower end of the fish calculator;
a display arranged on a front side of the fish calculator;
a housing having a front portion that includes an opening in which a weight of a measured fish is displayed, said housing including a rear portion that includes a loop fastener, said retractable tape measure and said weight measuring means being arranged within said housing; and,
a fastening strip extending through said loop fastener to surround the handle of the fishing rod to secure the fish calculator thereto.

2. The fish calculator of claim 1 wherein said retractable tape measure includes a free end that comprises a hook.

3. The fish calculator of claim 1 wherein said weight measuring means includes a hook extending from a bottom of the fish calculator.

4. The fish calculator of claim 1 wherein the housing includes a front portion that includes a window through which a weight of a fish is exhibited on the digital display that is arranged within the housing and being coupled to the weight measuring means.

5. The fish calculator of claim 1 wherein said housing further comprises a bulbous portion arranged atop an elongated portion.

6. The fish calculator of claim 1 further comprising a seal arranged in an opening of the housing through which a free end of the tape measure extends.

7. The fish calculator of claim 1 further comprising a seal arranged in an opening of the housing through which a portion of the weight measuring means extends.

8. The fish calculator of claim 1 further comprising:
a power source;
a digital display; and,
a switch arranged between said power source and the digital display for energizing said digital display to indicate a weight of a fish being weighed.

9. A fish calculator device that measures the length and weight of a fish and being coupled to a handle of a fishing rod, said device comprising:
a retractable tape measure;
a weight measuring means;
a digital display;
a housing having a front portion that includes a window through which a weight of a fish is exhibited on the digital display, said housing including a rear portion that includes a loop fastener;
a fastening strip extending through said loop fastener to surround the handle of the fishing rod;
a power source coupled to at least the digital display;
a power switch arranged on said housing and in-line between the power source and the digital dispaly for allowing power to flow from the power source to at least the digital display.

10. The device of claim 9 wherein said weight measuring means includes an electronic strain gauge that produces a control signal indicative of the weight of the fish.

11. The fish calculator of claim 9 wherein said retractable tape measure includes a free end that comprises a hook.

12. The fish calculator of claim 9 wherein said weight measuring means includes a hook extending from a bottom of the fish calculator.

13. The fish calculator of claim 9 wherein the housing includes a front portion that includes a window through which a weight of a fish is exhibited on the digital display that is arranged within the housing and being coupled to the weight measuring means.

14. The fish calculator of claim 9 wherein said housing further comprises a bulbous portion arranged atop an elongated portion.

15. The fish calculator of claim 9 further comprising a seal arranged in an opening of the housing through which a free end of the tape measure extends.

16. The fish calculator of claim 9 further comprising a seal arranged in an opening of the housing through which a portion of the weight measuring means extends.

17. A combination fishing rod and fish calculator comprising:
a fishing reel arranged at a handle end of said fishing rod;
a fish calculator arranged at the handle end of the fishing rod below the fishing reel and on an opposite of the fishing rod to the fishing reel;
said fish calculator comprising retractable tape measure arranged at an upper end of the fish calculator;
a weight measuring means arranged at a lower end of the fish calculator;
a display arranged on a front side of the fish calculator;
a housing having a front portion that includes an opening in which a weight of a measured fish is displayed, said housing including a rear portion that includes a loop fastener, said retractable tape measure and said weight measuring means being arranged within said housing; and,
a fastening strip extending through said loop fastener to surround the handle of the fishing rod to secure the fish calculator thereto.

18. The combination fishing rod and fish calculator of claim 17 further comprising:
a power source;
a digital display; and,
a switch arranged between said power source and the digital display for energizing said digital display to indicate a weight of a fish being weighed.

19. The combination fishing rod and fish calculator of claim 17 wherein said housing further comprises a bulbous portion arranged atop an elongated portion.

20. The combination fishing rod and fish calculator of claim 17 wherein at least one of said retractable tape measure and said weight measuring means includes a hook extending the fish calculator.
